(19) United States
(12) Patent Application Publication
(10) Pub. No.: US 2026/0027886 A1
(43) Pub. Date: Jan. 29, 2026

(54) P2 HYBRID MODULE FOR ELECTRIC VEHICLE

(71) Applicant: BorgWarner Inc., Auburn Hills, MI (US)

(72) Inventors: Matt Biederwolf, Fishers, IN (US); Brad Chamberlin, Pendleton, IN (US); Keith Van Maanen, Bloomfield Hills, MI (US); Katherine Riley, Alexandria, IN (US); Greg Beyerlein, Clarkston, MI (US); Chris Chirco, Romeo, MI (US); Tim Sailors, Carmel, IN (US); Firoz Jafri, Troy, MI (US); Wes Shaw, Troy, MI (US)

(21) Appl. No.: 19/282,429

(22) Filed: Jul. 28, 2025

Related U.S. Application Data
(60) Provisional application No. 63/676,119, filed on Jul. 26, 2024.

(51) Int. Cl. B60K 6/387; B60K 6/26; B60K 6/40; B60K 6/48; H02K 7/00; H02K 9/19

(52) U.S. Cl. CPC B60K 6/387; B60K 6/26; B60K 6/40; B60K 6/48; H02K 7/006; H02K 9/19

(57) ABSTRACT

A hybrid module for a vehicle is provided. The hybrid module includes an electric motor comprising a stator and a rotor. The hybrid module includes a torque converter operably coupled to the electric motor. An inner diameter of the stator in a radial direction is greater than an outer diameter of the torque converter in the radial direction.

### CROSS REFERENCE TO RELATED APPLICATIONS

This application claims the benefit of an earlier filing date from U.S. Provisional Application Ser. No. 63/676,119 filed Jul. 26, 2024, the entire disclosure of which is incorporated herein by reference.

### BACKGROUND OF THE INVENTION

The present disclosure relates to hybrid electric vehicle (EV) technologies, and particularly, to a P2 hybrid module which supports improved assembly, disassembly, and operational efficiency in electric vehicles and hybrid electric vehicles.

### BRIEF DESCRIPTION OF THE INVENTION

Embodiments of the present disclosure are directed to a hybrid module for a vehicle, including: an electric motor including a stator and a rotor; and a torque converter operably coupled to the electric motor, wherein an inner diameter of the stator in a radial direction is greater than an outer diameter of the torque converter in the radial direction.

Embodiments of the present disclosure are also directed to a device assembly, including: an electric motor including a stator and a rotor; a torque converter operably coupled to the electric motor, wherein an inner diameter of the stator in a radial direction is greater than an outer diameter of the torque converter in the radial direction.

Embodiments of the present disclosure are also directed to a hybrid module for a vehicle, including: an electric motor including: a stator; and a rotor including a rotor hub; and a torque converter operably coupled to the electric motor, wherein the torque converter is removably coupled to the rotor hub; wherein: an inner diameter of the stator in a radial direction is greater than an outer diameter of the torque converter in the radial direction; an outer diameter of a rotor hub foot of the rotor hub in the radial direction is sized such that the rotor hub foot does not overlap magnets of the rotor.

Further aspects supported by the present disclosure and features of example embodiments are illustrated in the accompanying drawings and/or described in the following description.

### BRIEF DESCRIPTION OF THE DRAWINGS

The following descriptions should not be considered limiting in any way. With reference to the accompanying drawings, like elements are numbered alike:

FIG. 1A and FIG. 1B illustrate perspective views of a device for an electric vehicle in accordance with one or more embodiments of the present disclosure.

FIG. 1C illustrates a cross sectional view of the device in accordance with one or more embodiments of the present disclosure.

FIGS. 2A and 2B illustrate example system operating modes of the device and associated torque flow among a P2 module, a torque converter, and a dry damper in accordance with one or more embodiments of the present disclosure.

FIG. 3 illustrates an example overview of hydraulic fluid distribution in the device in accordance with one or more embodiments of the present disclosure.

FIG. 4 illustrates aspects of the device in accordance with one or more embodiments of the present disclosure.

FIG. 5 illustrates example aspects of an axial length of the device in accordance with one or more embodiments of the present disclosure.

FIG. 6 illustrates aspects of a K0 clutch (K0 disconnect clutch) of the device in accordance with one or more embodiments of the present disclosure.

FIG. 7A illustrates aspects of the device and an inverter in accordance with one or more embodiments of the present disclosure.

FIG. 7B illustrates aspects of attaching the device in accordance with one or more embodiments of the present disclosure.

FIG. 8 illustrates an example of a ring attachment of the torque converter.

FIG. 9 illustrates an example flowchart of a method in accordance with one or more embodiments of the present disclosure.

### DETAILED DESCRIPTION OF THE INVENTION

According to one or more embodiments of the present disclosure, provided is a P2 hybrid module which supports improved assembly, disassembly, and operational efficiency in electric vehicles and hybrid electric vehicles.

Various drivetrain architectures exist for hybrid vehicles and are known as P1, P2, P3, and P4 configurations. In a P2 configuration, an electric motor is located between a combustion engine and a transmission, and the P2 configuration allows for the combustion engine to be disconnected from the transmission. The P2 configuration supports the incorporation of hybrid technology into an existing combustion engine powertrain with minimal modification to the existing powertrain.

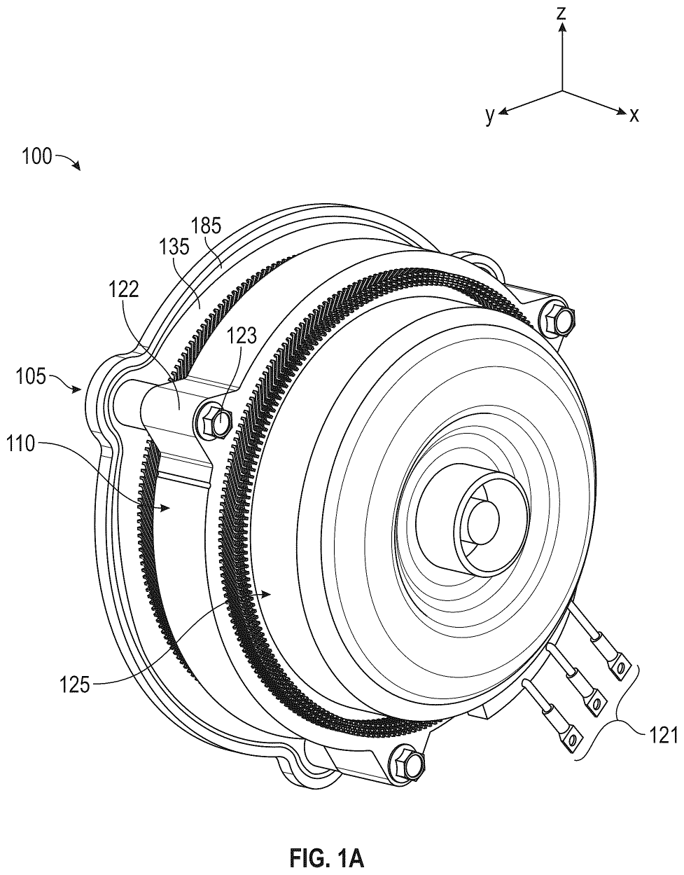

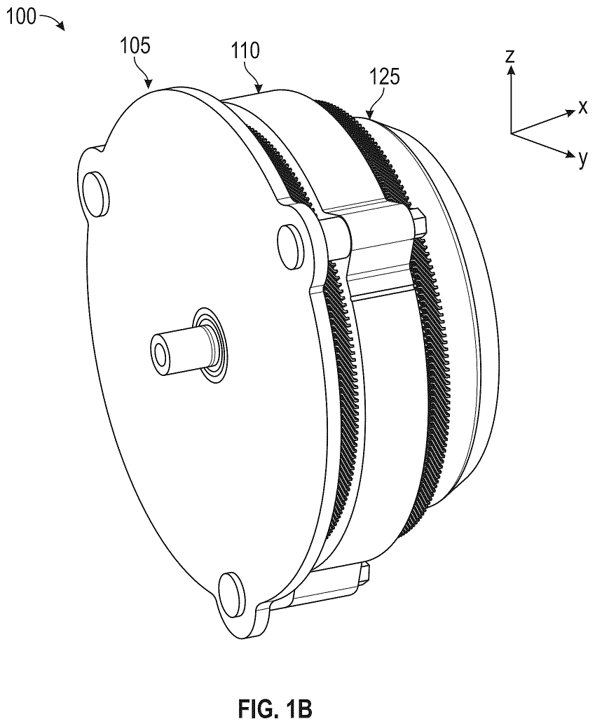

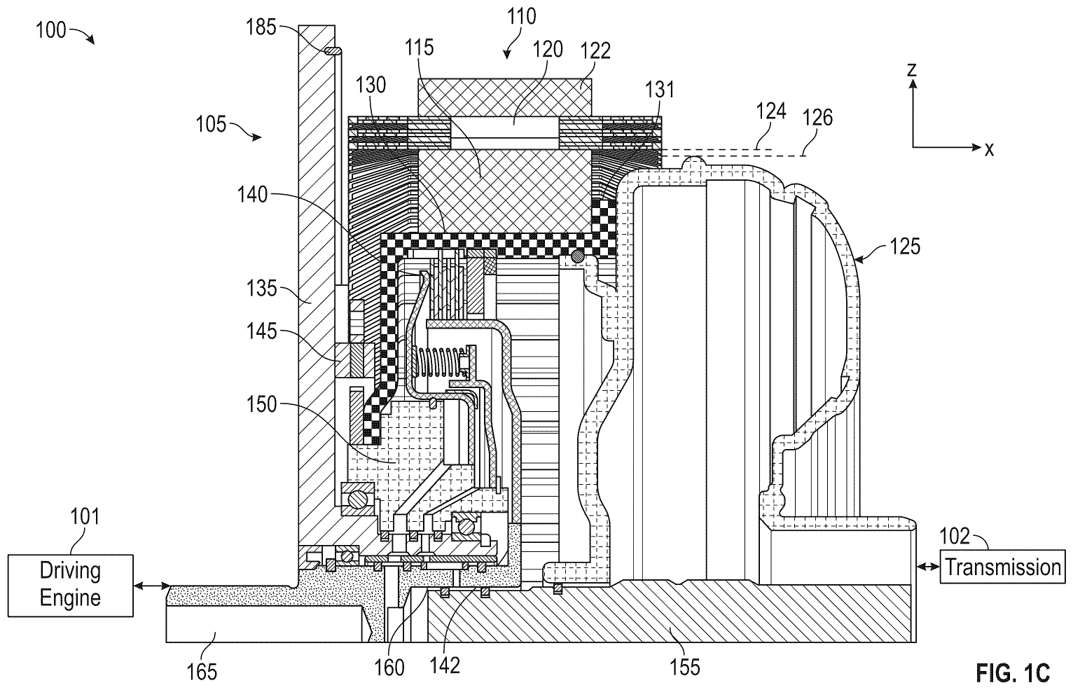

FIG. 1A and FIG. 1B illustrate perspective views of a device 100 for an electric vehicle in accordance with one or more embodiments of the present disclosure. FIG. 1C illustrates a cross sectional view of the device 100 in accordance with one or more embodiments of the present disclosure. The device 100 may be referred to herein as a P2 hybrid module, a P2 hybrid module assembly, a hybrid module, or a device assembly according to a P2 configuration. Example aspects of the internal configuration, mounting features, and serviceability features of the device 100 will be described herein.

The device 100 is positioned according to a P2 configuration. The device 100 is positioned between a drive engine 101 and a transmission 102 of a motorized vehicle (not illustrated). Non-limiting examples of the motorized vehicle include an automotive vehicle or other self-propelled vehicles.

Aspects of the drive engine 101 and the transmission 102 are not illustrated in detail. Rather, the drive engine 101 and the transmission 102 are shown coupled to the respective rotary input and output components of the device 100, which are configured to rotate about a central axis x. The drive engine 101 may an internal combustion engine, but embodiments of the present disclosure are not limited thereto.

The device 100 includes a P2 module 105 (also referred to herein as a hybrid module) and a torque converter 125.

The P2 module 105 includes an electric motor 110, a rotor hub 130 having a rotor hub foot 131, a closeout plate 135 (also referred to herein as a plate structure), a K0 clutch 140, a resolver 145, a clutch pack 150, a clutch basket 152, and a transmission input shaft 155. The P2 module 105 further includes a support member 142 and a member 165.

The electric motor 110 includes a rotor 115 and a stator 120. The electric motor 110 is drivingly coupled to the K0 clutch 140 and drivingly coupled to the torque converter 125. In some aspects, the electric motor 110 is drivingly coupled to the torque converter 125 via a splined engagement. Each of the rotor 115 and the stator 120 may include magnets. For example, the rotor 115 may include magnets 116. So as not to obstruct from the figure, a single magnet 116 is illustrated.

The rotor hub 130 may serve as a structure to which the torque converter 125 may be removably coupled. In accordance with one or more embodiments of the present disclosure, the device 100 supports relatively easier detachment or decoupling of the torque converter 125 from the rotor hub 130 compared to other approaches.

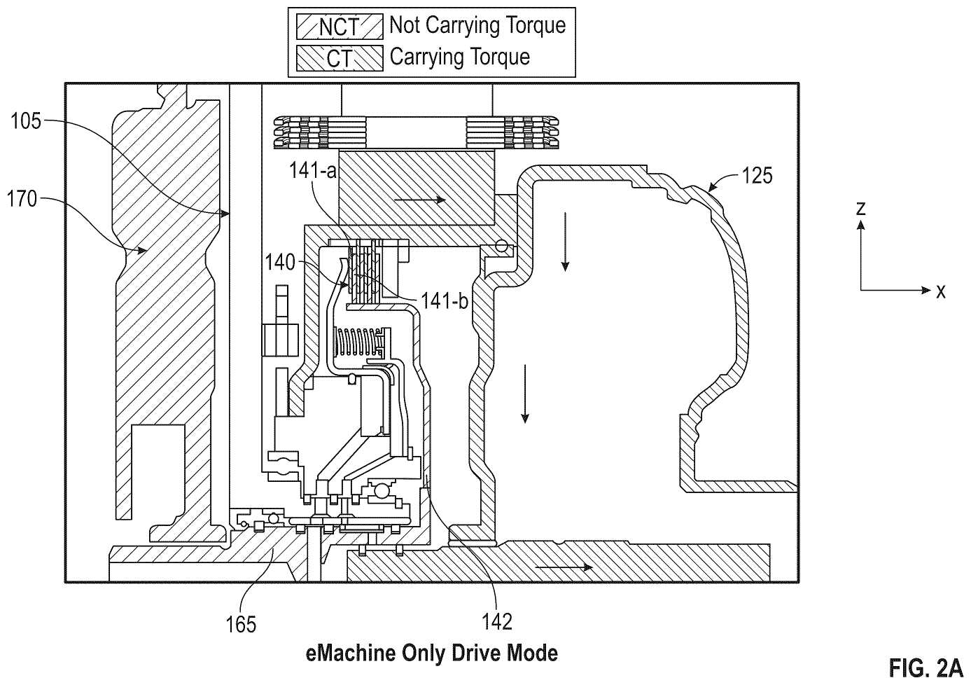

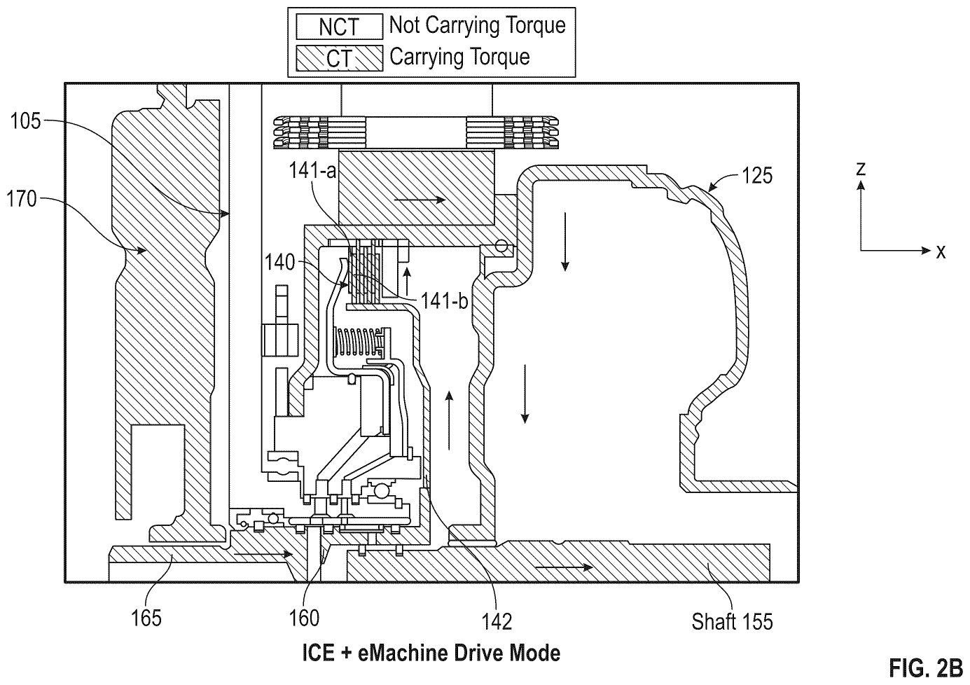

The K0 clutch 140 may be a hydraulic or wet clutch. The K0 clutch 140 may engage the drive engine 101 and the electric motor 110 with the torque converter 125 such that the torque converter 125 is driven by the drive engine 101 and the electric motor 110 (e.g., according to an internal combustion engine (ICE) plus e-Machine drive mode later described with reference to FIG. 2B). The K0 clutch 140 may engage the electric motor 110 with the torque converter 125 and disengage the drive engine 101 from the torque converter 125 such that the torque converter 125 is driven exclusively by the electric motor 110 (e.g., an e-Machine only drive mode later described with reference to FIG. 2A).

In some aspects, one or more components of the P2 module 105 may be supported within a housing that is rigidly mounted to the drive engine 101 or other fixed structure of the vehicle.

The device 100 supports improved assembly, disassembly, and operational efficiency compared to other approaches, example aspects of which will be described herein with reference to the figures herein.

For example, the features of the device 100 described herein support flexible installation methods, such as providing and shipping the P2 module 105 as an assembly or subsystem which is separate from the torque converter 125.

In accordance with one or more embodiments of the present disclosure, with reference to FIG. 1A and FIG. 1C, the inner diameter of the stator lamination of the stator 120 (e.g., in the z-direction) is larger than the outer diameter (e.g., in the z-direction) of the torque converter 125, which may support improved ease of assembly and disassembly compared to other approaches. With reference to FIG. 1C, an end of the inner diameter of the stator lamination of the stator 120 is indicated by line 124, an end of the outer diameter of the torque converter 125 is indicated by line 126. The sizing of the inner diameter of the stator 120 and the outer diameter of the torque converter 125 may support removal of the stator assembly (i.e., the complete structure of the stator 120, including the core and windings) by a user, thereby allowing access to the rotor hub foot 131 and the area corresponding to the rotor hub foot 131.

In the area corresponding to the rotor hub foot 131, the torque converter 125 may be detached from the device 100 via prying, for example, using a tool. Detaching the torque converter 125 from the device 100 may provide access to the K0 clutch 140.

In some embodiments, discreet angular sections forming a portion of the rotor hub foot 131 may serve as locations supportive of detaching (i.e., prying) the torque converter 125 from the rotor hub foot 131, and accordingly, from the device 100. In some aspects, the angular sections may be formed non-continuously or according to a predetermined spacing at respective portions of the rotor hub foot 131. In some other aspects, the angular sections may be formed continuously (i.e., complete 360 degrees) of the rotor hub foot 131.

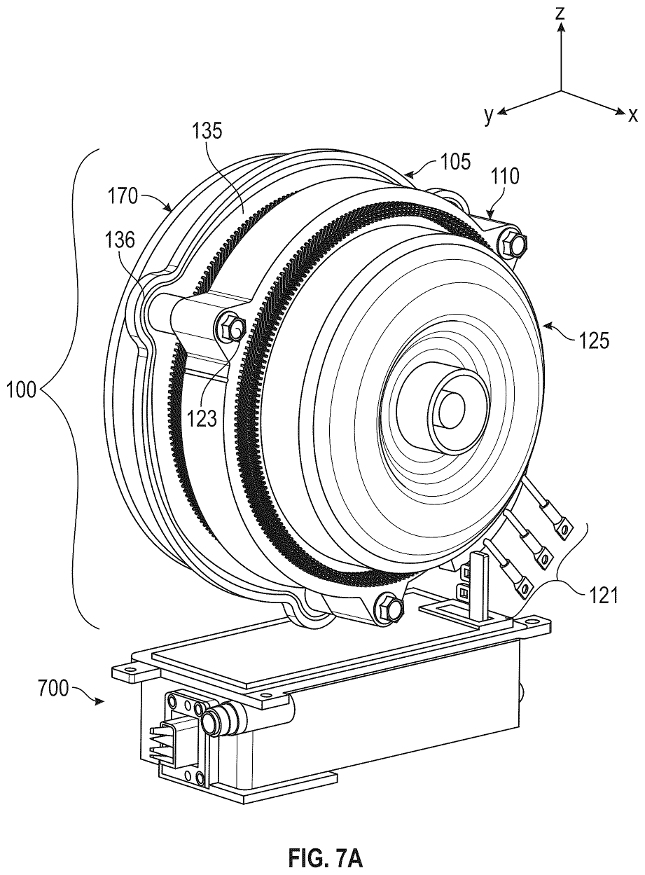

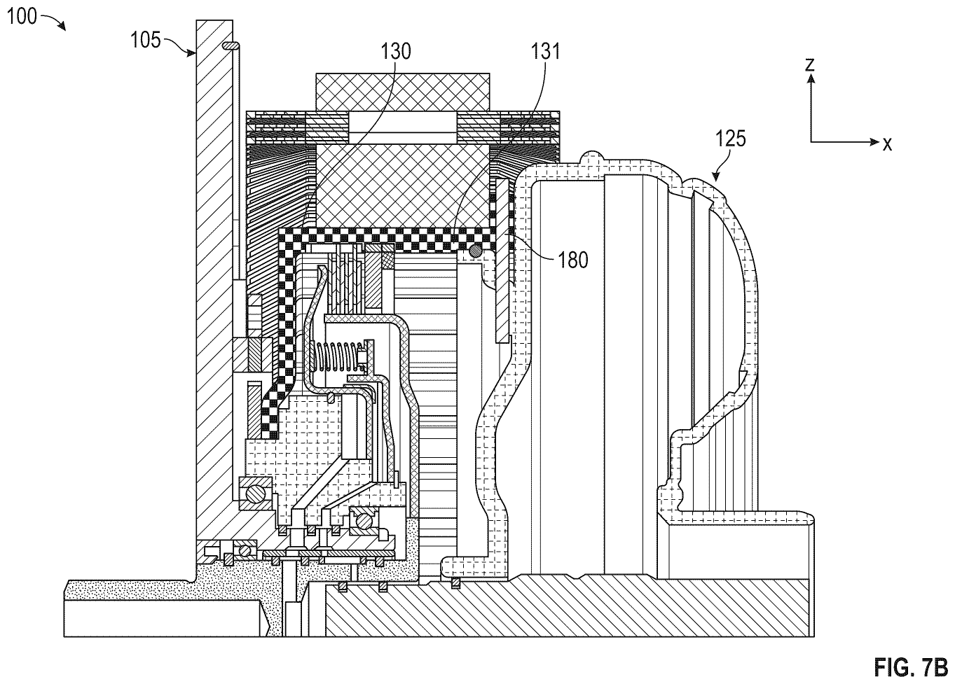

In another embodiment, a pin 180 (later illustrated at FIG. 7B) may be pressed in a hole in the rotor hub foot 131 and into the torque converter 125. The pin 180 may lock the torque converter 125 in rotational position. In an example of disassembling the device 100, after removal of the stator 120, the torque converter 125 may be unlocked from the device 100 by removing (pulling or pressing) the pin 180.

Additionally, or alternatively, the torque converter 125 may be detachable from the device 100 via a combination of prying and pin removal described herein.

In some aspects, features of the rotor hub foot 131 may support oil flow from the clutch area corresponding to the clutch 140, through the rotor hub foot 131, and onto the end turns of the stator 120, and the oil flow may cool the stator 120.

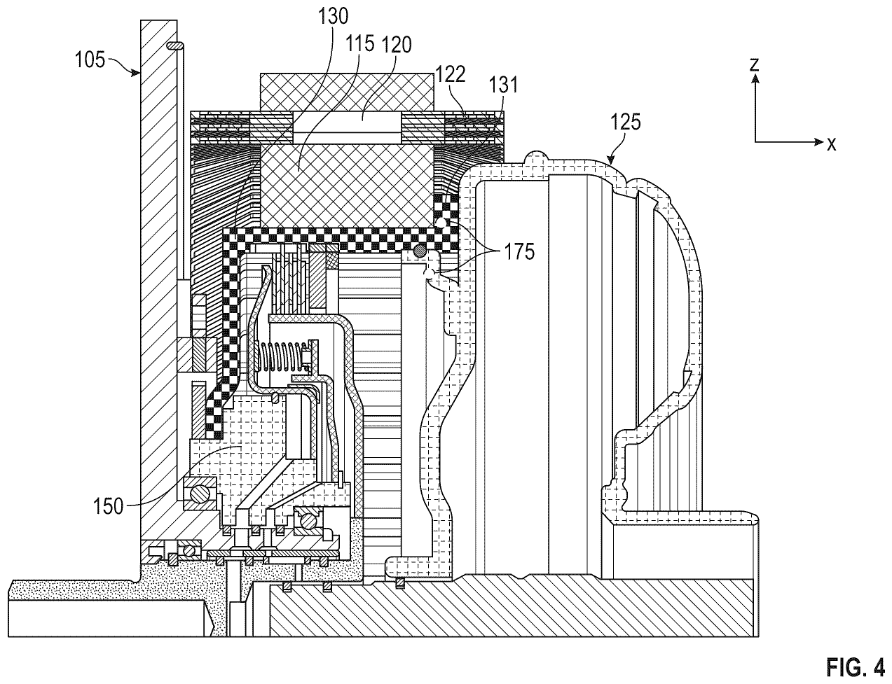

In an example in which the angular sections of the rotor hub foot 131 are formed non-continuously (i.e., the non-continuous rotor hub foot 131), oil may flow from the clutch area via spaces defined by the angular sections of the rotor hub foot 131. Additionally, or alternatively, the rotor hub foot 131 may include holes 175 (illustrated at FIG. 4) which enable the flow of oil through the rotor hub foot 131. Additionally, or alternatively, the rotor hub 130 may include holes 175 (illustrated at FIG. 4) which enable the flow of oil through the rotor hub 130.

In some aspects, the device 100 may include a ring 185 on the closeout plate 135 which is configured to pilot around the outside diameter of the stator lamination of the stator 120. The ring 185 may support locating the stator 120. Additionally, or alternatively, the device 100 may include pins (not illustrated) at the closeout plate 135, and the pins may be used to locate the stator.

In some aspects, with reference to FIGS. 1A through 1C, the stator lamination of the stator 120 may have ears 122. In an example, the stator 120 may be detachably coupled to the closeout plate 135 by inserting bolts 123 (also referred to herein as stator bolts) through holes defined in the ears 122 and screwing down the bolts 123 to the closeout plate 135. The described implementations of the ring 185, pins, ears 122, and bolts 123 may support ease of removal and installation of the stator 120 with respect to the device 100 and the electric motor 110.

Embodiments of the present disclosure support detaching the torque converter 125 from the device 100 (e.g., removing the torque converter 125 for service). In some examples, the torque converter 125 may be assembled to the rotor hub 130 with a snap ring (not illustrated), press fit, thermal fit, knurl, key, pin 180 (as previously mentioned) or any other similar device.

In an example implementation using the snap ring, the rotor hub 130 or the torque converter 125 may include a snap ring pocket (not illustrated). The snap ring pocket (not illustrated) may be ramped or chamfered on the right side (e.g., the x-direction), allowing relatively easier removal of the torque converter 125. The snap ring pocket may be formed as a groove configured to receive the snap ring.

In the example illustrated at FIG. 1C, the rotor hub foot 131 is located at the right side of the figure. In an example, one side (e.g., facing in the negative x-direction) of the rotor hub foot 131 may act as an axial stop for the rotor 115, and another side (e.g., facing in the x-direction) of the rotor hub foot 131 may act as a stop for the torque converter 125.

Features of the rotor hub foot 131 may prevent flux leakages. For example, the outer diameter of the rotor hub foot 131 may be sized such that the rotor hub foot 131 does not cover the magnets on the rotor 115.

Features of the rotor hub foot 131 may shield the torque converter 125 from the magnetic flux of the rotor 115. In a non-limiting example, the thickness of the rotor hub foot 131 may be greater than 3 mm, which may provide effective shielding from the magnetic flux. In some aspects, the thickness (e.g., greater than 3 mm) of the rotor hub foot 131 may further provide effective resistance against thrust/ballooning of the torque converter 125.

In some aspects, by including the closeout plate 135 in the device 100, the device 100 may be built separately from the transmission 102. In an example, after assembly of the device 100, the device 100 may be mounted in or to the transmission 102.

In accordance with one or more embodiments of the present disclosure, the stator end turns on the left side of the stator 120 may be less than about 24 mm, and the surface of the closeout plate 135 facing the stator 120 may be flat.

In some aspects, the stator end turns on the right side of the stator 120 may be relatively longer compared to the stator end turns on the left side, due to the torque converter 125 having a smaller diameter than the inner diameter of the stator lamination of the stator 120.

Leads 121 of the stator 120 are detachably couplable to an inverter 700 (later illustrated at FIG. 7A). In an example aspect, the leads 121 are mounted at the right side of the stator 120 (and accordingly, the device 100) to accommodate for a case in which the lead area has a bus bar (not illustrated) or series connection which extends higher than the stator end turns of the stator 120. Due to the surface of the closeout plate 135 facing the stator 120 being flat, clearance on the right side of the closeout plate 135 may not be present for a bus bar or series connections.

In some cases, a hairpin stator may typically have longer end turns on the weld side of the hairpins. Therefore, for an example embodiment in which the stator 120 is a hairpin type stator, the welds are located on the right side of the stator 120. Accordingly, for example, the leads 121 may therefore extend from the weld side of the hairpins. In an alternative example embodiment, the stator 120 may be continuous hairpin winding type stator, in which the stator 120 does not have a weld end.

According to one or more embodiments of the present disclosure, the device 100 may include a dry damper 170. The dry damper 170 may serve to mitigate torsional vibrations within the drivetrain (e.g., vibrations generated by the drive engine 101 and the electric motor 110). Example aspects of the dry damper 170 are later illustrated and described with reference to FIGS. 2A, 2B, 5, and 7A.

The device 100 may include a ring 185 on the closeout plate 135. In an example, the ring 185 is a sealing component which seals the wet oil cavity from the dry damper 170. The ring 185 may be formed of, for example, any material suitable for providing scaling functionality described herein. The dry damper 170 may be located to the left of the closeout plate 135.

FIGS. 2A and 2B illustrate example system operating modes of the device 100 and associated torque flow among the P2 module 105, the torque converter 125, and the dry damper 170 in accordance with one or more embodiments of the present disclosure. The device 100 may support an e-Machine only drive mode and an internal combustion engine (ICE) plus e-Machine drive mode.

With reference to FIG. 2A, in the e-Machine only drive mode, the rotor 115, rotor hub 130 (including the rotor hub foot 131), the torque converter 125, the transmission input shaft 155, and portions of the K0 clutch 140 (e.g., friction plates 141-a) are carrying torque, as designated by shaded regions ‘CT’. Further, in the e-Machine only drive mode, friction plates 141-b, a support member 142, the member 165, and the dry damper 170 are not carrying torque, as designated by shaded regions ‘NCT’. The direction of the torque is indicated by the arrows illustrated in FIG. 2A.

With reference to FIG. 2B, in the ICE plus e-Machine drive mode, the rotor 115, rotor hub 130 (including the rotor hub foot 131), the torque converter 125, the transmission input shaft 155, and the same portions of the K0 clutch 140 described with reference to FIG. 2A are carrying torque, as designated by shaded regions ‘CT’. In addition, the friction plates 141-b, the support member 142, the member 165, and the dry damper 170 are carrying torque, as designated by shaded regions ‘CT’. The direction of the torque is indicated by the arrows illustrated in FIG. 2B.

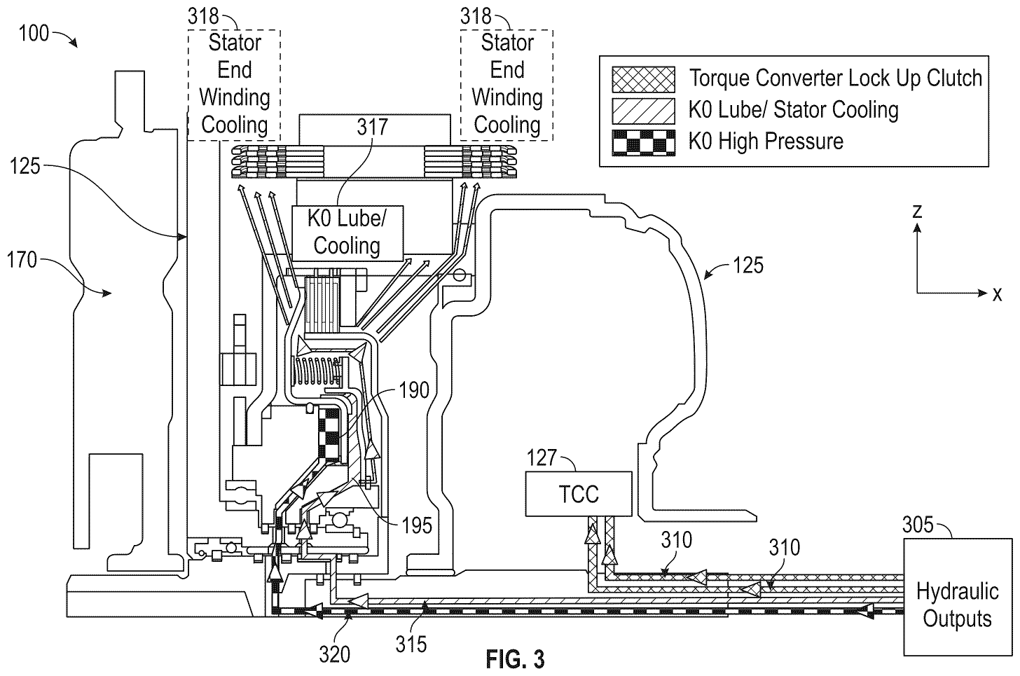

FIG. 3 illustrates an example overview of hydraulic fluid distribution in the device 100 in accordance with one or more embodiments of the present disclosure.

With reference to FIG. 3, the torque converter 125 may include a torque converter clutch 127 (also referred to herein as a torque converter lock-up clutch or TCC). The clutch 140 may further include a piston assembly 190 (including pistons) and a centrifugal balancer 195.

In accordance with one or more embodiments of the present disclosure, via the transmission input shaft 155, the device 100 may distribute hydraulic fluid (hydraulic outputs 305) received from the transmission 102 to components of the device 100. The device 100 may distribute the hydraulic fluid via feeds 310 (also referred to herein as TCC feed), feed 315 (also referred to herein as centrifugal balancer/clutch pack/stator feed), and feed 320 (also referred to herein as K0 pressure feed or K0 high pressure feed).

Feeds 310 are high pressure feeds which come from the transmission 102. Feeds 310 control the torque converter clutch 127 within the torque converter 125.

Feed 315 is a low pressure feed which provides lubrication. Feed 315 is provided to the centrifugal balancer 195, which is located behind the piston assembly 190. Feed 315 further provides cooling 317 (K0 Lube/cooling) to the clutch pack of the clutch 140. Feed 315 is then attributed outwards and provides cooling 318 to the end windings (i.e., stator end windings) of the P2 module 105.

Feed 320 is a high pressure feed provided by the transmission 102. Feed 320 controls actuation of hydraulic pistons of the piston assembly 190.

Accordingly, for example, the device 100 supports feeding of the hydraulic outputs 305 (i.e., feeds 310, feed 315, feed 320) through the cross-section of the transmission input shaft 155, and across rotating components, to various components of the clutch 140 and to the torque converter clutch 127.

FIG. 4 illustrates aspects of the device 100 in accordance with one or more embodiments of the present disclosure. In the example of FIG. 4, the locations of the holes 175 may allow oil to flow onto the right stator end turn of the stator 120. Each of the rotor hub 130 and the rotor hub foot 131 may include respective holes 175 which enable the flow of oil.

With reference to FIG. 4, the clutch basket 152 may have holes 176 which allow oil to exit the clutch basket 152 (e.g., due to centrifugal pressure), enter the machine main cavity, and cool the clutch 140, the rotor 115, and eventually the stator 120.

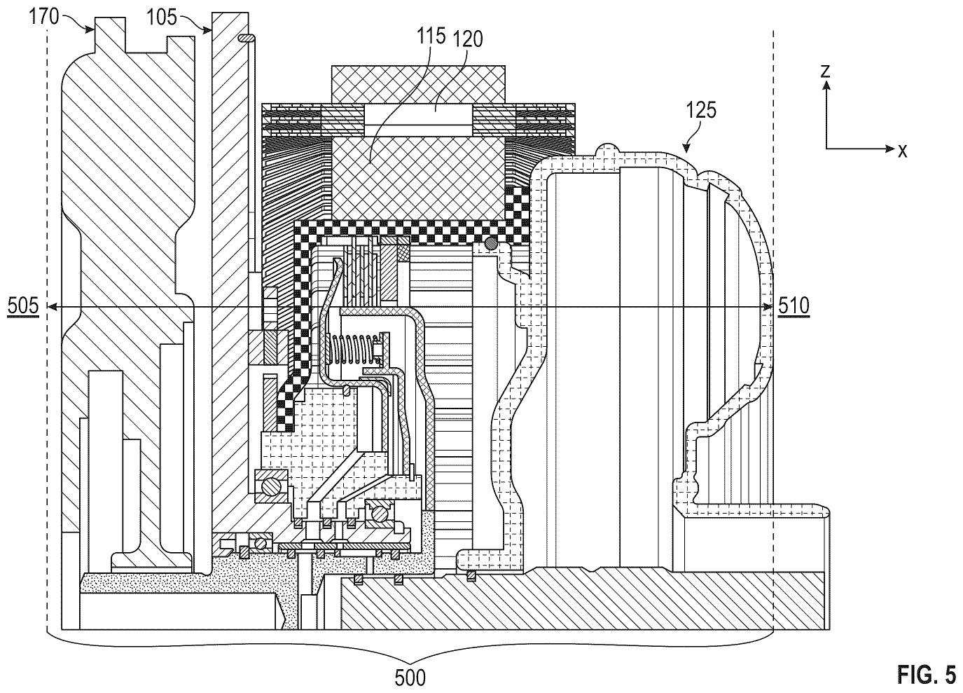

FIG. 5 illustrates example aspects of an axial length 500 of the device 100 in accordance with one or more embodiments of the present disclosure.

In a non-limiting example, the axial length 500 from an engine mounting face 505 of the device 100 to a rear face 510 of the torque converter 125 may be equal to 221.5 mm. In accordance with one or more embodiments of the present disclosure, the features of the device 100 described herein provide an axial length 500 which is relatively less than respective axial lengths of comparative assemblies which include a P2 module, a dry damper, a motor (including a rotor and a stator), and a torque converter.

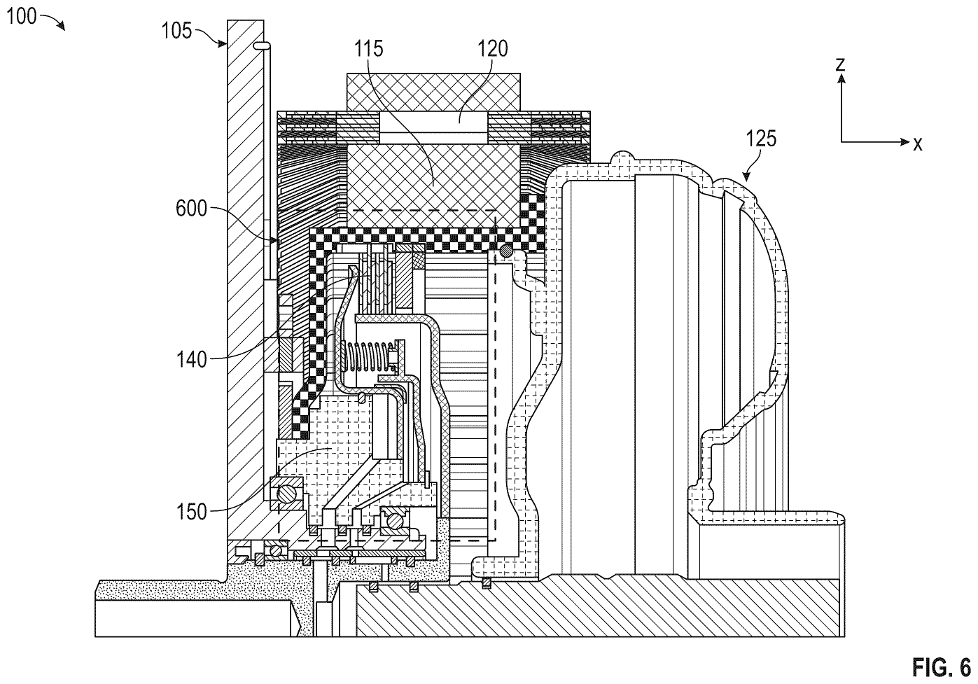

FIG. 6 illustrates aspects of the K0 clutch 140 (K0 disconnect clutch) of the device 100 in accordance with one or more embodiments of the present disclosure. Aspects of the K0 clutch 140 with reference to the indicator box 600 are provided in Table 1 below.

TABLE 1

| | Clutch parameter | Comment |
|---|---|---|
| Friction Outer Diameter | 215 mm | |
| Friction Inner Diameter | 195 mm | |
| Friction Material | BW4390 | |
| Friction Plates Per Pack | 4 double sided | Potential to reduce to 4 |
| | (8 friction | or 6 friction surfaces |
| | surfaces) | for improved efficiency |
| Torque Capacity | 780 Nm @ | Target: 780 Nm |
| | 1200 kPa | (Max), 720 Nm |
| | | (Nom) at 1200 kPa |

FIG. 7A illustrates aspects of the device 100 and an inverter 700 in accordance with one or more embodiments of the present disclosure.

In an example, the device 100 and inverter 700 may be accommodated and installed in a vehicle (not illustrated). The inverter 700 is electrically couplable to the stator 120 of the electric motor 110 included in the device 100. The inverter 700 may convert direct current (DC) electrical power from the battery of the vehicle into alternating current (AC) power, and the vehicle may apply the AC power to drive the stator windings of the stator 120 and operate the electric motor 110. In some aspects, the inverter 700 may facilitate regenerative braking by converting AC power generated by the electric motor 110 back into DC power, and the vehicle may recharge the battery using the DC power. The detachable coupling of the leads 121 to the inverter 700 also supports ease of assembly, disassembly, and serviceability of the device 100.

In accordance with one or more embodiments of the present disclosure, the bolts 123 for securing the electric motor 110 to the closeout plate 135 of the module 105 may be positioned according to a motor bolt pattern. Based on the motor bolt pattern, portions 136 (bumps) of the closeout plate 135 may be outside the diameter of the dry damper 170. The portions 136 (bumps) may serve as reference on thread engagement, and embodiments of the present disclosure are not limited thereto the example sizes, shapes, positions, and quantity illustrated herein. For example, embodiments of the present disclosure may include modifying the motor bolt pattern such that the portions 136 (bumps) are enlarged, without interfering with operation of the device 100.

FIG. 7B illustrates aspects of attaching the device 100 in accordance with one or more embodiments of the present disclosure. With reference to FIG. 7B, the pin 180 may be removably inserted in a hole in the rotor hub foot 131 and into the torque converter 125, locking the torque converter 125 in rotational position.

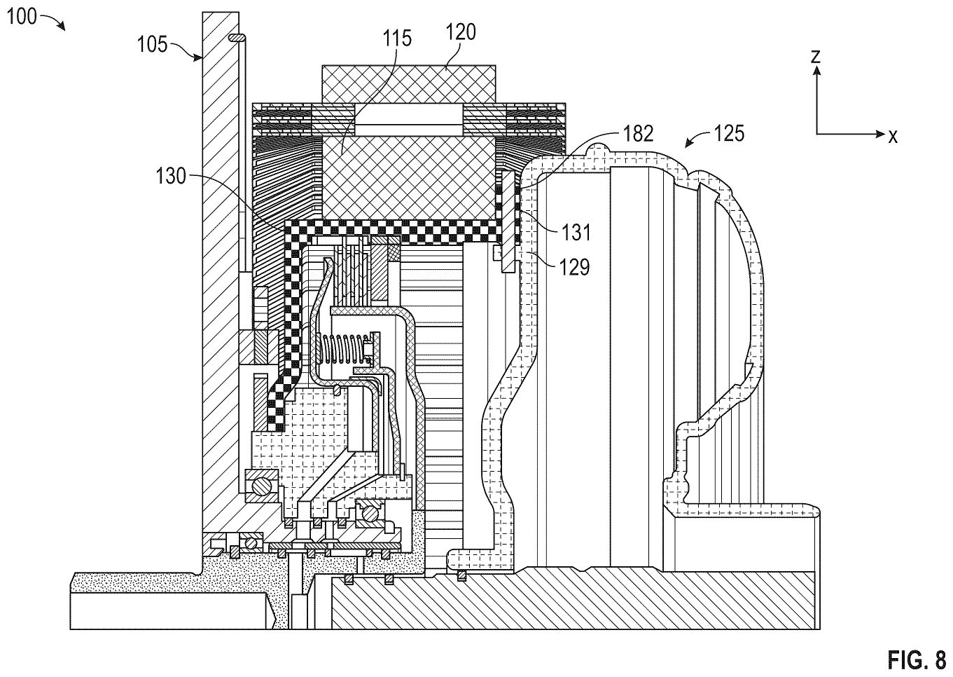

FIG. 8 illustrates an example of a ring attachment of the torque converter 125.

In an example, a weldment 129 on the torque converter 125 may connect the torque converter 125 to the rotor hub 130. In some aspects, the weldment 129 may be a relatively simple ring (e.g., a snap ring) connected to the outer diameter or inner diameter of the rotor hub foot 131. In some embodiments, the weldment 129 may be attached to the torque converter 125 via an attachment mechanism 182. Non-limiting examples of the attachment mechanism 182 include a pin, screw, set screw, or the like.

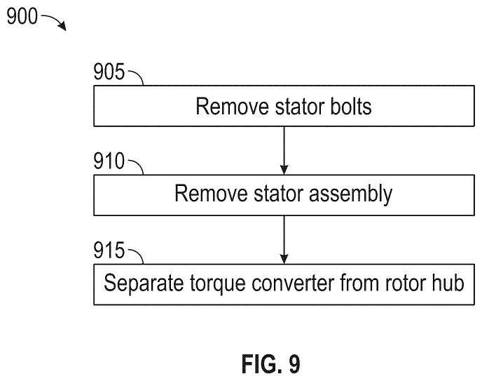

FIG. 9 illustrates an example flowchart of a method 900 in accordance with one or more embodiments of the present disclosure. The method 900 is described with reference to the device 100 described herein.

The method 900 supports a process for acquiring access to the clutch basket of the device 100, allowing a user to service or repair the clutch basket.

At block 905, the method 900 includes removing the bolts 123.

At block 910, the method 900 includes removing the stator assembly (i.e., the complete structure of the stator 120, including the core and windings).

At block 915, the method 900 includes separating the torque converter 125 from the rotor hub 130.

In some embodiments, separating the torque converter 125 from the rotor hub 130 may include first removing a pin 180 (as described with reference to FIG. 7B) or an attachment mechanism 182 (as described with reference to FIG. 8), and then separating the torque converter 125 from the rotor hub 130.

Additionally, or alternatively, separating the torque converter 125 from the rotor hub 130 may include prying the torque converter 125 from the rotor hub 130 using a tool as described herein.

Embodiments of the present disclosure support reassembling the device 100 in an order reverse to the method 900 described herein.

As has been described herein, embodiments of the present disclosure provide a P2 module 105 in which an included component (e.g., a faulty component) may be disassembled from the P2 module 105 and replaced into the P2 module 105, without replacing other components of the P2 module 105. Aspects of the P2 module 105 support detaching and removing any or all of the included components and similarly reassembling any or all of the same removed components back into the P2 module 105.

For example, for some other P2 modules, in the case of a faulty component (e.g., a faulty torque converter, a faulty stator, a faulty clutch), the entire assembly is replaced. That is, for some other P2 modules, the electric motor (including the stator assembly and rotor assembly), torque converter, clutch, are a permanently attached component set, and failure of any of the components would involve assembling a completely new P2 module of permanently attached components.

As has been described herein, in accordance with one or more embodiments of the present disclosure, a device 100 is provided which includes a P2 module 105 for a vehicle.

The P2 module 105 includes: an electric motor 110 including a stator 120 and a rotor 115; and a torque converter 125 operably coupled to the electric motor 110, wherein an inner diameter of the stator 120 in a radial direction is greater than an outer diameter of the torque converter 125 in the radial direction.

In some aspects, the stator 120 is removable from the P2 module 105 in an axial direction, without removing the torque converter 125 from the P2 module 105.

The P2 module 105 may further include a plate structure located at first axial end of the P2 module 105, wherein: the stator 120 is detachably mounted to the plate structure; and the torque converter 125 is located at a second axial end of the P2 module 105.

In some aspects, a surface of the plate structure which faces the stator 120 is flat.

The P2 module 105 may further include a rotor hub 130, wherein the torque converter 125 is removably coupled to the rotor hub 130.

In some aspects, removing the stator 120 from the P2 module 105 exposes at least a portion of the rotor hub 130 and at least a portion of the torque converter 125; and the torque converter 125 is removable from the P2 module 105 in a state in which at least the portion of the rotor hub 130 and at least the portion of the torque converter 125 are exposed.

In some aspects, the rotor hub 130 includes a rotor hub foot 131; a hole defined in the rotor hub foot 131 penetrates through the rotor hub foot 131 and a portion of the torque converter 125; and the torque converter 125 is removably coupled to the rotor hub foot 131 by a pin 180 or a screw which is removably inserted into the hole.

In some aspects, the torque converter 125 is removably coupled to the rotor hub 130 by a snap ring 185; and the snap ring 185 is radially compressible and is radially received within a groove formed in the torque converter 125 or the rotor hub 130.

In some aspects, the rotor hub 130 includes a rotor hub foot 131 defined by one or more angular sections; the torque converter 125 is in removable contact with the rotor hub foot 131 at the one or more angular sections; and the torque converter 125 is removable from the rotor hub foot 131 based on pressure applied to one or more pry points which correspond to the one or more angular sections.

In some aspects, the hybrid module 105 may include a clutch 140 including oil and configured to selectively engage the electric motor 110 with the torque converter 125, wherein at least a portion of the oil flows from the clutch 140 to the stator 120 of the electric motor 110, via one or more openings defined by the one or more angular sections.

The P2 module 105 may further include a clutch 140 including oil and configured to selectively engage the electric motor 110 with the torque converter 125, wherein: the rotor hub 130 includes one or more holes which penetrate through the rotor hub 130; and at least a portion of the oil flows from the clutch 140 to the stator 120 of the electric motor 110, via the one or more holes.

In some aspects, the rotor hub 130 includes a rotor hub foot 131 extending outward in a radial direction which is perpendicular to an axial direction of the P2 module 105; the rotor hub foot 131 is configured to prevent movement of the rotor 115 in the axial direction; and the rotor hub foot 131 is configured to prevent movement of the torque converter 125 in a direction opposite the axial direction.

In some aspects, the rotor hub 130 includes a rotor hub foot 131; and an outer diameter of the rotor hub foot 131 in the radial direction is sized such that the rotor hub foot 131 does not overlap magnets 116 of the rotor 115.

In some aspects, the stator 120 includes a first set of end turns and a second set of end turns; the second set of end turns are relatively closer to the torque converter 125 compared to the first set of end turns; and the second set of end turns are relatively longer in an axial direction of the P2 module 105 compared to the first set of end turns.

In some aspects, the stator 120 includes a first set of end turns and a second set of end turns; the first set of end turns are relatively further from the torque converter 125 compared to the second set of end turns; and a length of each end turn of the first set of end turns is less than 24 mm.

The P2 module 105 may further include a bus bar electrically coupled to leads 121 of the stator 120, wherein the leads 121, the bus bar, or both are located at an axial side of the P2 module 105 which is associated with the torque converter 125.

The P2 module 105 may further include: a clutch 140 configured to selectively engage the torque converter 125 with one or more of the electric motor 110 and a drive engine 101 of the vehicle; and a transmission 102 input shaft 155 operably coupled to the clutch 140, the torque converter 125, and a transmission 102 of the vehicle, wherein the P2 module 105 is configured to distribute hydraulic fluid from the transmission 102 to one or more of the electric motor 110, the clutch 140, and the torque converter 125, via the transmission 102 input shaft 155.

The P2 module 105 may further include: a device assembly, wherein the electric motor 110 and a rotor hub 130 constitute a portion of the device assembly and are assembly coupled to one another; and a dry damper 170 operably coupled to the device assembly and a drive engine 101 of the vehicle, wherein: the device assembly is located between the dry damper 170 and the torque converter 125 in an axial direction of the P2 module 105; an engine mounting face 505 of the P2 module 105 is defined by an end of the dry damper 170 which faces away from the device assembly; a rear face 510 of the P2 module 105 is defined by an end of the torque converter 125 which faces away from the device assembly; and an axial length 500 from the engine mounting face 505 to the rear face 510 satisfies a target range.

The P2 module 105 may further include a clutch 140 configured to selectively engage the torque converter 125 with one or more of the electric motor 110 and a drive engine 101 of the vehicle, wherein the P2 module 105 is configured to transmit power to a transmission 102 of the vehicle via the torque converter 125, based on the selective engagement of the torque converter 125 with the one or more of the electric motor 110 and the drive engine 101.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Set forth below are some embodiments of the foregoing disclosure:

Embodiment 1. A hybrid module for a vehicle, comprising: an electric motor comprising a stator and a rotor; and a torque converter operably coupled to the electric motor, wherein an inner diameter of the stator in a radial direction is greater than an outer diameter of the torque converter in the radial direction.

Embodiment 2. The hybrid module according to any prior embodiment, wherein the stator is removable from the hybrid module in an axial direction, without removing the torque converter from the hybrid module.

Embodiment 3. The hybrid module according to any prior embodiment, further comprising a plate structure located at first axial end of the hybrid module, wherein: the stator is detachably mounted to the plate structure; and the torque converter is located at a second axial end of the hybrid module.

Embodiment 4. The hybrid module of embodiment 3, wherein a surface of the plate structure which faces the stator is flat.

Embodiment 5. The hybrid module according to any prior embodiment, further comprising a rotor hub, wherein the torque converter is removably coupled to the rotor hub.

Embodiment 6. The hybrid module according to any prior embodiment, wherein: removing the stator from the hybrid module exposes at least a portion of the rotor hub and at least a portion of the torque converter; and the torque converter is removable from the hybrid module in a state in which at least the portion of the rotor hub and at least the portion of the torque converter are exposed.

Embodiment 7. The hybrid module according to any prior embodiment, wherein: the rotor hub comprises a rotor hub foot; a hole defined in the rotor hub foot penetrates through the rotor hub foot and a portion of the torque converter; and the torque converter is removably coupled to the rotor hub foot by a pin or a screw which is removably inserted into the hole.

Embodiment 8. The hybrid module according to any prior embodiment, wherein: the torque converter is removably coupled to the rotor hub by a snap ring; and the snap ring is radially compressible and is radially received within a groove formed in the torque converter or the rotor hub.

Embodiment 9. The hybrid module according to any prior embodiment, wherein: the rotor hub comprises a rotor hub foot defined by one or more angular sections; the torque converter is in removable contact with the rotor hub foot at the one or more angular sections; and the torque converter is removable from the rotor hub foot based on pressure applied to one or more pry points which correspond to the one or more angular sections.

Embodiment 10. The hybrid module of embodiment 9, further comprising: a clutch comprising oil and configured to selectively engage the electric motor with the torque converter, wherein at least a portion of the oil flows from the clutch to the stator of the electric motor, via one or more openings defined by the one or more angular sections.

Embodiment 11. The hybrid module according to any prior embodiment, further comprising: a clutch comprising oil and configured to selectively engage the electric motor with the torque converter, wherein: the rotor hub comprises one or more holes which penetrate through the rotor hub; and at least a portion of the oil flows from the clutch to the stator of the electric motor, via the one or more holes.

Embodiment 12. The hybrid module according to any prior embodiment, wherein: the rotor hub comprises a rotor hub foot extending outward in a radial direction which is perpendicular to an axial direction of the hybrid module; the rotor hub foot is configured to prevent movement of the rotor in the axial direction; and the rotor hub foot is configured to prevent movement of the torque converter in a direction opposite the axial direction.

Embodiment 13. The hybrid module according to any prior embodiment, wherein: the rotor hub comprises a rotor hub foot; and an outer diameter of the rotor hub foot in the radial direction is sized such that the rotor hub foot does not overlap magnets of the rotor.

Embodiment 14. The hybrid module according to any prior embodiment, wherein: the stator comprises a first set of end turns and a second set of end turns; the second set of end turns are relatively closer to the torque converter compared to the first set of end turns; and the second set of end turns are relatively longer in an axial direction of the hybrid module compared to the first set of end turns.

Embodiment 15. The hybrid module according to any prior embodiment, wherein: the stator comprises a first set of end turns and a second set of end turns; the first set of end turns are relatively further from the torque converter compared to the second set of end turns; and a length of each end turn of the first set of end turns is less than 24 mm.

Embodiment 16. The hybrid module according to any prior embodiment, further comprising a bus bar electrically coupled to leads of the stator, wherein the leads, the bus bar, or both are located at an axial side of the hybrid module which is associated with the torque converter.

Embodiment 17. The hybrid module according to any prior embodiment, further comprising: a clutch configured to selectively engage the torque converter with one or more of the electric motor and a drive engine of the vehicle; and a transmission input shaft operably coupled to the clutch, the torque converter, and a transmission of the vehicle, wherein the hybrid module is configured to distribute hydraulic fluid from the transmission to one or more of the electric motor, the clutch, and the torque converter, via the transmission input shaft.

Embodiment 18. The hybrid module according to any prior embodiment, further comprising: a device assembly, wherein the electric motor and a rotor hub constitute a portion of the device assembly and are assembly coupled to one another; and a dry damper operably coupled to the device assembly and a drive engine of the vehicle, wherein: the device assembly is located between the dry damper and the torque converter in an axial direction of the hybrid module; an engine mounting face of the hybrid module is defined by an end of the dry damper which faces away from the device assembly; a rear face of the hybrid module is defined by an end of the torque converter which faces away from the device assembly; and an axial length from the engine mounting face to the rear face satisfies a target range.

Embodiment 19. The hybrid module according to any prior embodiment, further comprising a clutch configured to selectively engage the torque converter with one or more of the electric motor and a drive engine of the vehicle, wherein the hybrid module is configured to transmit power to a transmission of the vehicle via the torque converter, based on the selective engagement of the torque converter with the one or more of the electric motor and the drive engine.

Embodiment 20. A device assembly, comprising: an electric motor comprising a stator and a rotor; a torque converter operably coupled to the electric motor, wherein an inner diameter of the stator in a radial direction is greater than an outer diameter of the torque converter in the radial direction.

Embodiment 21. A hybrid module for a vehicle, comprising: an electric motor comprising: a stator; and a rotor comprising a rotor hub; and a torque converter operably coupled to the electric motor, wherein the torque converter is removably coupled to the rotor hub; wherein: an inner diameter of the stator in a radial direction is greater than an outer diameter of the torque converter in the radial direction; an outer diameter of a rotor hub foot of the rotor hub in the radial direction is sized such that the rotor hub foot does not overlap magnets of the rotor.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A hybrid module for a vehicle, comprising:
an electric motor comprising a stator and a rotor; and
a torque converter operably coupled to the electric motor,
wherein an inner diameter of the stator in a radial direction is greater than an outer diameter of the torque converter in the radial direction.

2. The hybrid module of claim 1, wherein the stator is removable from the hybrid module in an axial direction, without removing the torque converter from the hybrid module.

3. The hybrid module of claim 1, further comprising a plate structure located at first axial end of the hybrid module, wherein:
the stator is detachably mounted to the plate structure; and
the torque converter is located at a second axial end of the hybrid module.

4. The hybrid module of claim 3, wherein a surface of the plate structure which faces the stator is flat.

5. The hybrid module of claim 1, further comprising a rotor hub, wherein the torque converter is removably coupled to the rotor hub.

6. The hybrid module of claim 5, wherein:
removing the stator from the hybrid module exposes at least a portion of the rotor hub and at least a portion of the torque converter; and
the torque converter is removable from the hybrid module in a state in which at least the portion of the rotor hub and at least the portion of the torque converter are exposed.

7. The hybrid module of claim 5, wherein:
the rotor hub comprises a rotor hub foot;
a hole defined in the rotor hub foot penetrates through the rotor hub foot and a portion of the torque converter; and
the torque converter is removably coupled to the rotor hub foot by a pin or a screw which is removably inserted into the hole.

8. The hybrid module of claim 5, wherein:
the torque converter is removably coupled to the rotor hub by a snap ring; and
the snap ring is radially compressible and is radially received within a groove formed in the torque converter or the rotor hub.

9. The hybrid module of claim 5, wherein:
the rotor hub comprises a rotor hub foot defined by one or more angular sections;
the torque converter is in removable contact with the rotor hub foot at the one or more angular sections; and
the torque converter is removable from the rotor hub foot based on pressure applied to one or more pry points which correspond to the one or more angular sections.

10. The hybrid module of claim 9, further comprising:
a clutch comprising oil and configured to selectively engage the electric motor with the torque converter,
wherein at least a portion of the oil flows from the clutch to the stator of the electric motor, via one or more openings defined by the one or more angular sections.

11. The hybrid module of claim 5, further comprising:
a clutch comprising oil and configured to selectively engage the electric motor with the torque converter,
wherein:
the rotor hub comprises one or more holes which penetrate through the rotor hub; and
at least a portion of the oil flows from the clutch to the stator of the electric motor, via the one or more holes.

12. The hybrid module of claim 5, wherein:
the rotor hub comprises a rotor hub foot extending outward in a radial direction which is perpendicular to an axial direction of the hybrid module;
the rotor hub foot is configured to prevent movement of the rotor in the axial direction; and
the rotor hub foot is configured to prevent movement of the torque converter in a direction opposite the axial direction.

13. The hybrid module of claim 5, wherein:
the rotor hub comprises a rotor hub foot; and
an outer diameter of the rotor hub foot in the radial direction is sized such that the rotor hub foot does not overlap magnets of the rotor.

14. The hybrid module of claim 1, wherein:
the stator comprises a first set of end turns and a second set of end turns;
the second set of end turns are relatively closer to the torque converter compared to the first set of end turns; and
the second set of end turns are relatively longer in an axial direction of the hybrid module compared to the first set of end turns.

15. The hybrid module of claim 1, wherein:
the stator comprises a first set of end turns and a second set of end turns;
the first set of end turns are relatively further from the torque converter compared to the second set of end turns; and
a length of each end turn of the first set of end turns is less than 24 mm.

16. The hybrid module of claim 1, further comprising a bus bar electrically coupled to leads of the stator,
wherein the leads, the bus bar, or both are located at an axial side of the hybrid module which is associated with the torque converter.

17. The hybrid module of claim 1, further comprising:
a clutch configured to selectively engage the torque converter with one or more of the electric motor and a drive engine of the vehicle; and
a transmission input shaft operably coupled to the clutch, the torque converter, and a transmission of the vehicle,
wherein the hybrid module is configured to distribute hydraulic fluid from the transmission to one or more of the electric motor, the clutch, and the torque converter, via the transmission input shaft.

18. The hybrid module of claim 1, further comprising:
a device assembly, wherein the electric motor and a rotor hub constitute a portion of the device assembly and are assembly coupled to one another; and
a dry damper operably coupled to the device assembly and a drive engine of the vehicle,
wherein:
the device assembly is located between the dry damper and the torque converter in an axial direction of the hybrid module;
an engine mounting face of the hybrid module is defined by an end of the dry damper which faces away from the device assembly;
a rear face of the hybrid module is defined by an end of the torque converter which faces away from the device assembly; and
an axial length from the engine mounting face to the rear face satisfies a target range.

19. The hybrid module of claim 1, further comprising a clutch configured to selectively engage the torque converter with one or more of the electric motor and a drive engine of the vehicle,
wherein the hybrid module is configured to transmit power to a transmission of the vehicle via the torque converter, based on the selective engagement of the torque converter with the one or more of the electric motor and the drive engine.

20. A device assembly, comprising:
an electric motor comprising a stator and a rotor;
a torque converter operably coupled to the electric motor,
wherein an inner diameter of the stator in a radial direction is greater than an outer diameter of the torque converter in the radial direction.

21. A hybrid module for a vehicle, comprising:
an electric motor comprising:
a stator; and
a rotor comprising a rotor hub; and
a torque converter operably coupled to the electric motor, wherein the torque converter is removably coupled to the rotor hub;
wherein:
an inner diameter of the stator in a radial direction is greater than an outer diameter of the torque converter in the radial direction;
an outer diameter of a rotor hub foot of the rotor hub in the radial direction is sized such that the rotor hub foot does not overlap magnets of the rotor.
